(19) United States
(12) Patent Application Publication
(10) Pub. No.: US 2004/0015583 A1
(43) Pub. Date: Jan. 22, 2004

(54) Network management apparatus

(76) Inventors: Mark A Barrett, Ipswich (GB); Robert E Booth, Suffolk (GB)

Correspondence Address: NIXON & VANDERHYE, PC, 1100 N GLEBE ROAD, 8TH FLOOR, ARLINGTON, VA, 22201-4714, US

(21) Appl. No.: 10/415,818

(22) PCT Filed: Nov. 27, 2001
(86) PCT No.: PCT/GB01/05229

(30) Foreign Application Priority Data
Nov. 30, 2000 (EP) 00310634.1

(51) Int. Cl. G06F 15/173

(52) U.S. Cl. 709/224

(57) ABSTRACT

The invention is concerned with a method of monitoring one or more network devices and exploits the realisation that monitoring and testing can occur by analysing the content and source of broadcast messages. Embodiments of the invention are implemented on otherwise conventional devices, and gather and process information that has been broadcast during data communications between network devices.

In one embodiment of the invention the or each network device is located in a different respective domain in a network, and the or each network device is operable to broadcast one or more types of multicast data to one or more other network devices in other different domains. Moreover the or each network device is operable to receive, as input, data broadcast from the one or more other network devices, and the method includes the steps of:

(i) identifying one or more of said network devices for monitoring;

(ii) connecting to the or each identified network device;

(iii) broadcasting multicast data to the or each identified network devices;

(iv) receiving one or more types of messages representative of multicast data broadcast from the or each identified network devices at intervals; and

(v) storing the or each received messages for analysis thereof.

In another arrangement, there is a method of testing operation of one or more network devices comprising the steps of:

a) identifying one or more of said network devices;

b) broadcasting one or more test data to at least one of the identified network devices, the one or more test data comprising a source network address corresponding to a source of the test data, a Multicast Group address and a network address of a network device at which the test data has been registered by the source;

c) receiving messages representative of the test data at intervals; and

d) analysing the received messages in accordance with a plurality of predetermined criteria so as to establish how the or each identified network device processed the test data, thereby testing operation of the or each network device.

Advantages of the invention can readily be seen when compared with conventional network management tools. For example, there is a relative reduction in network traffic—the invention works on information contained in messages that have been broadcast between peers and are therefore already in the network. Thus there is no need to probe peers, and thus no need to generate additional network traffic for the purposes of network monitoring and testing. The invention is described as applied to multicast and unicast data, in particular corresponding to the MSDP and GMPLS protocols respectively.

The present invention relates to a network management apparatus, and is particularly suitable for monitoring network devices and data that are broadcast between network devices.

One of the most commonly used Multicast protocols to control transport of multicast data is Protocol Independent Multicast—Sparse Mode (PIM-SM). PIM-SM is an intra-domain protocol, so that, if a source is transmitting content S1, G1 within domain A, only devices within domain A can receive content corresponding to S1, G1. In order to provide inter-domain connectivity for PIM-SM multicast content, a new protocol, Multicast Source Discovery Protocol (MSDP), which is widely used by Internet Service Providers, has been developed.

One of the consequences of using MSDP, and thus taking advantage of inter-domain connectivity, is an increase in multicast traffic over the Internet, because customers now have access to more multicast content than they had before. Increasing volumes of traffic place increasing demands on network devices and network capacity, which generates a corresponding need for adequate network management methods. These network management methods need to monitor loadings on network devices and identify problems, preferably without introducing a significant volume of test-related network traffic.

The Simple Network Management Protocol (SNMP) is typically used to probe network devices and retrieve information about the operating conditions of such devices. SNMP Messages are sent to a Management Information Base (MIB), which stores a range of operating statistics (written under the control of the operating system in operation on the device) on the devices. However, management systems that rely on SNMP clearly generate monitoring-specific network traffic. If the status of a network device changes regularly, as is the case with MSDP traffic (described below), then a significant volume of SNMP traffic could be generated. A group within the National Science Foundation has developed a tool, known as “Looking Glass™” which performs queries, including MSDP-related queries, on multicast-enabled network devices (among other devices). The tool, which is accessible over the Internet (http://www.ncne.nlanr.net/tools/mlq2.phtml), gathers information via TELNET (a terminal emulation protocol of Transmission Control Protocol/Internet Protocol (TCP/IP)) by actually logging on to the network device and running a script that probes the MIB and various other storage areas thereon. However, this tool has several limitations: firstly additional network traffic, in the form of TELNET packets, is generated; and secondly the owner of the network device has to provide authentication information to the tool operator so that the operator can retrieve this information from the device. This may give rise to security concerns, as, if any of the probing TELNET packets were intercepted, the interceptor could potentially derive sufficient information from the packets to access the device without the knowledge of the device owner. In addition, and as a practical issue, the nature of the query is limited, and there is no post-processing of the data returned from the probed device.

Workers from CAIDA and the University of California at Santa Barbara have collaboratively developed a tool named “Mantra™”, which collects data, via TELNET, at predetermined intervals from selected routers. This data includes information from MBGP table, BGP table, Multicast routing table and MSDP SA cache, and is used to provide a snapshot of information. The data retrieved from the tables is summarised into graphs to show the size of tables, number of sources, number of groups etc. For Mantra™ to provide information that is useful, it needs to collect data from routers at key network locations, and is dependent upon information being available at a Command Line Interface (CLI) of a respective router being accurate. To date, only six routers situated at public exchange points are being monitored by Mantra™, and a significant amount of control state data (that passes through their private peering points) may be absent from the data collected from these routers. Thus the tool generates additional network traffic when probing the devices, and there is no guarantee that the information that is retrieved is accurate. In addition, there are security concerns similar to those discussed above in respect of LookingGlass™.

According to the present invention, there is provided a method or system as set out in the accompanying claims. Further aspects, features and advantages of the present invention will be apparent from the following description of preferred embodiments of the invention, which are by way of example only and refer to the accompanying drawings, in which

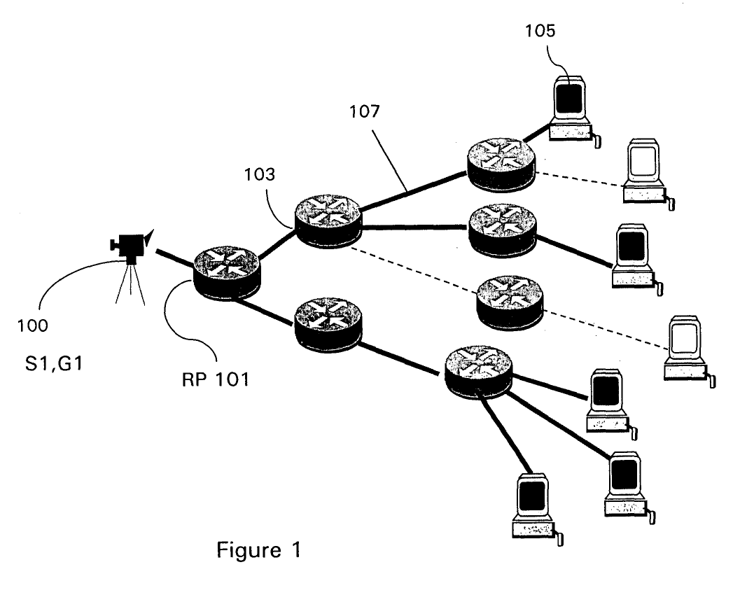

FIG. 1 is a schematic diagram showing basic operation of a Multicast tree building protocol;

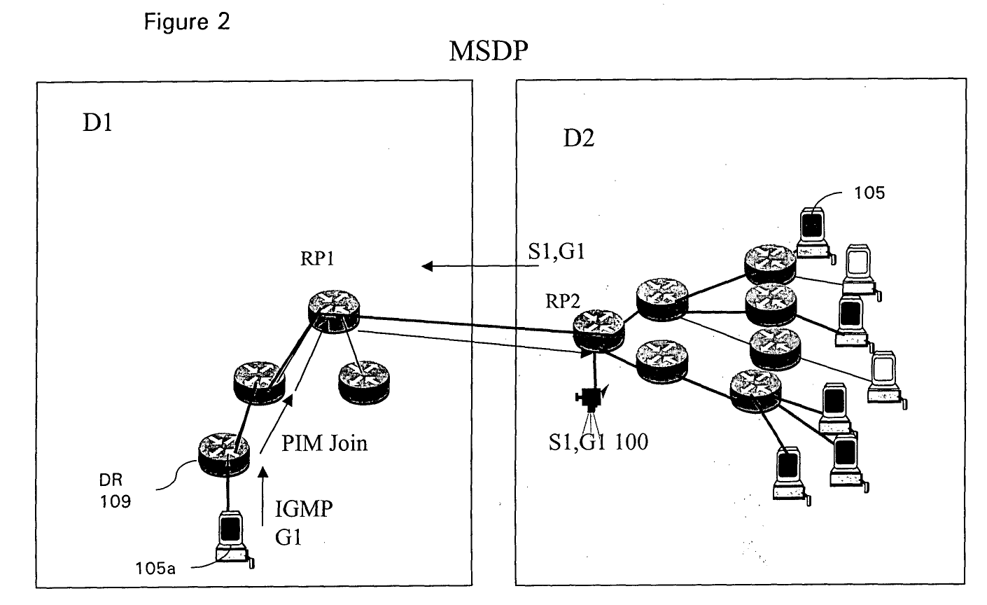

FIG. 2 is a schematic diagram showing Inter-domain multicast connectivity in accordance with the Multicast Source Discovery Protocol (MSDP);

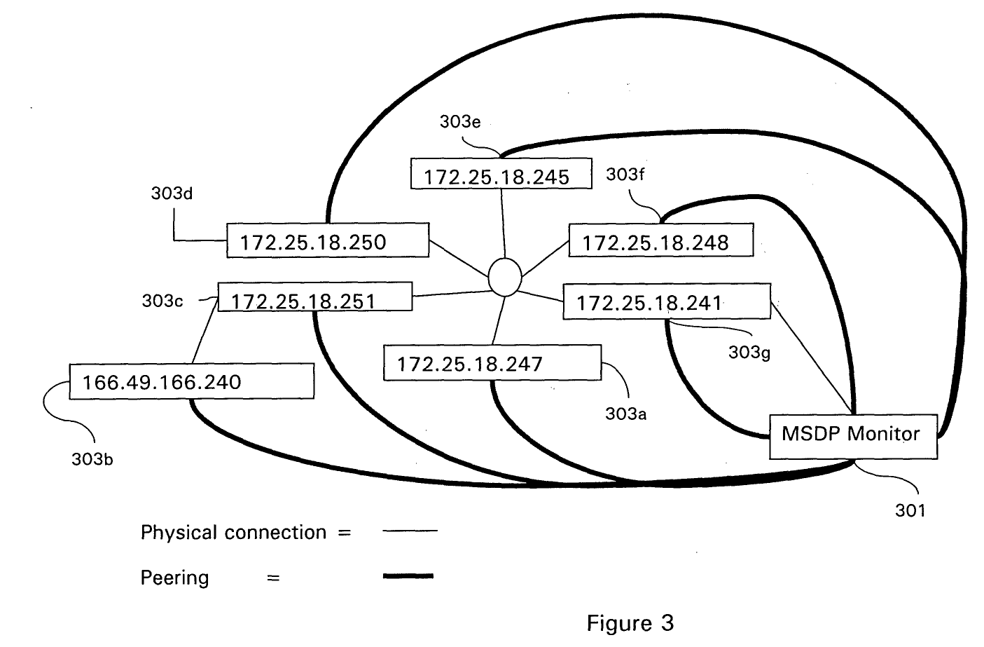

FIG. 3 is a schematic diagram showing a first embodiment of apparatus for monitoring inter-domain multicast connectivity according to the invention located in a network;

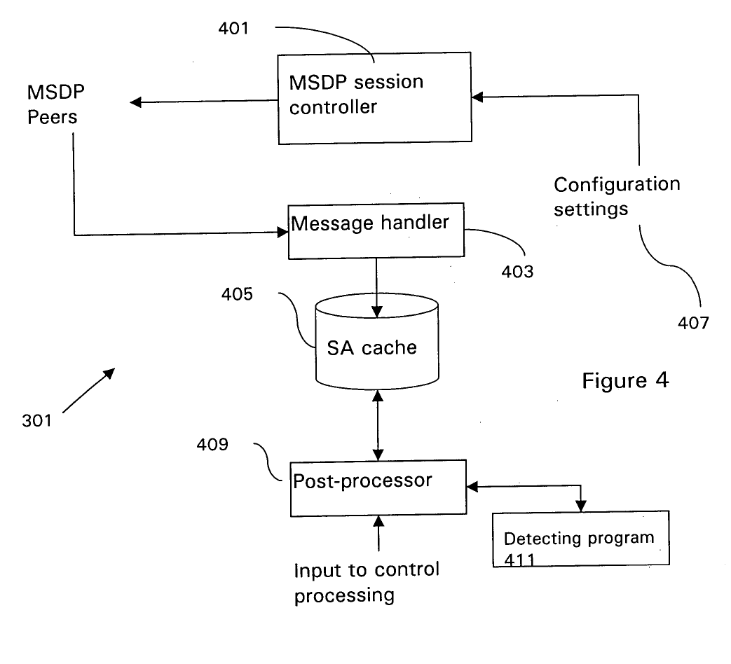

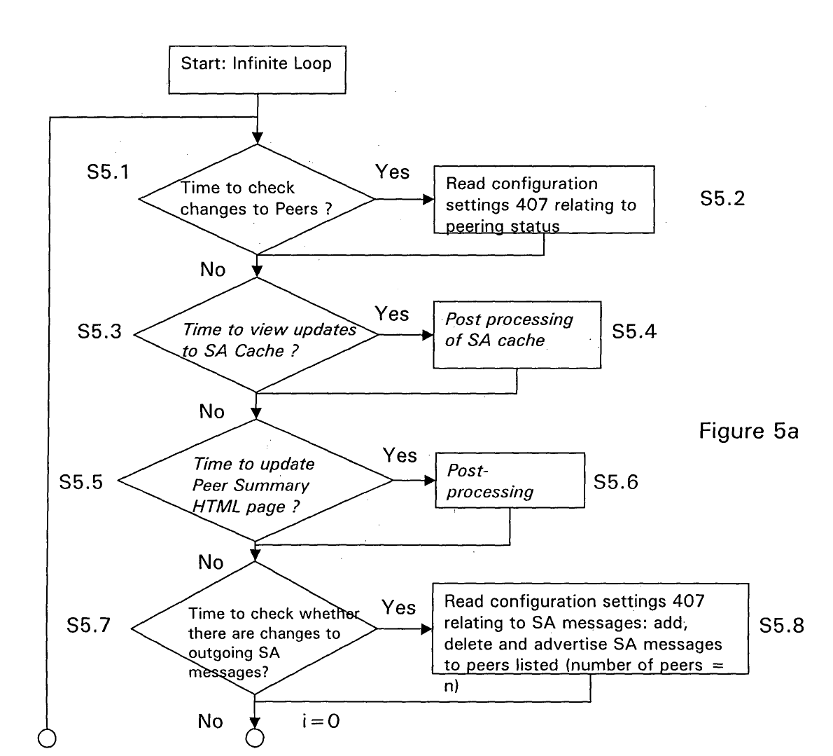

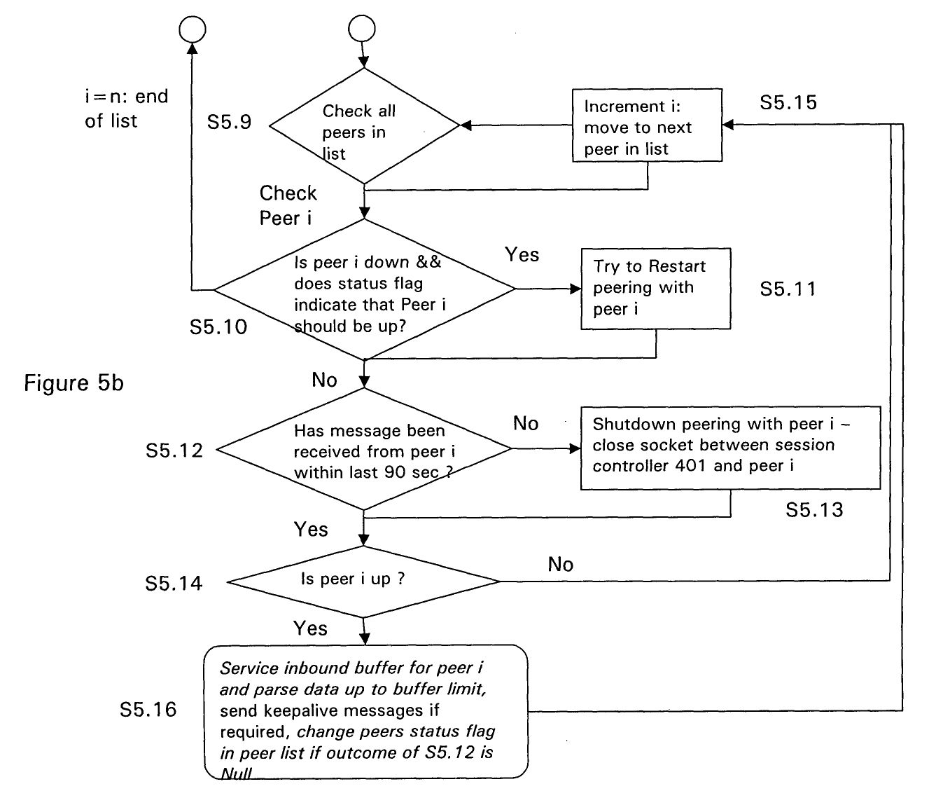

FIG. 4 is a schematic block diagram showing a first embodiment of network management apparatus according to the invention; FIGS. 5a and 5b comprise a schematic flow diagram showing a flow of events processed by the embodiment of FIG. 4;

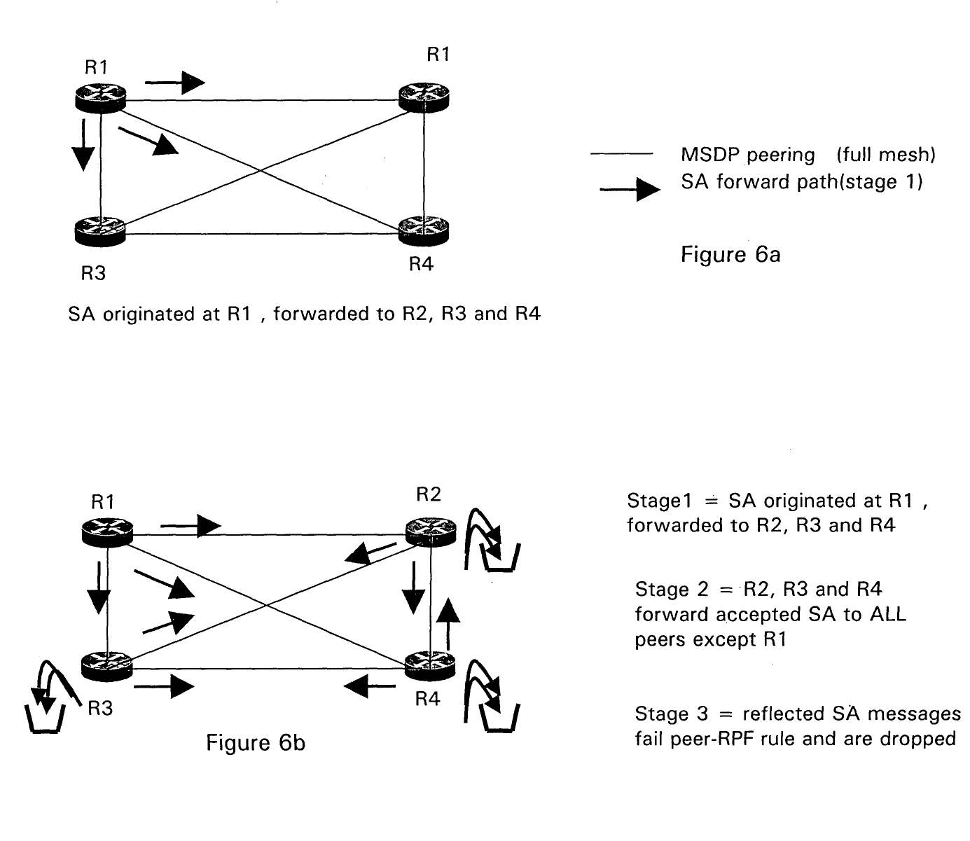

FIG. 6a is a schematic diagram showing MSDP peering in a mesh arrangement of four MSDP enabled routers;

FIG. 6b is a schematic diagram showing Reverse Packet Forwarding in operation between four MSDP enabled routers;

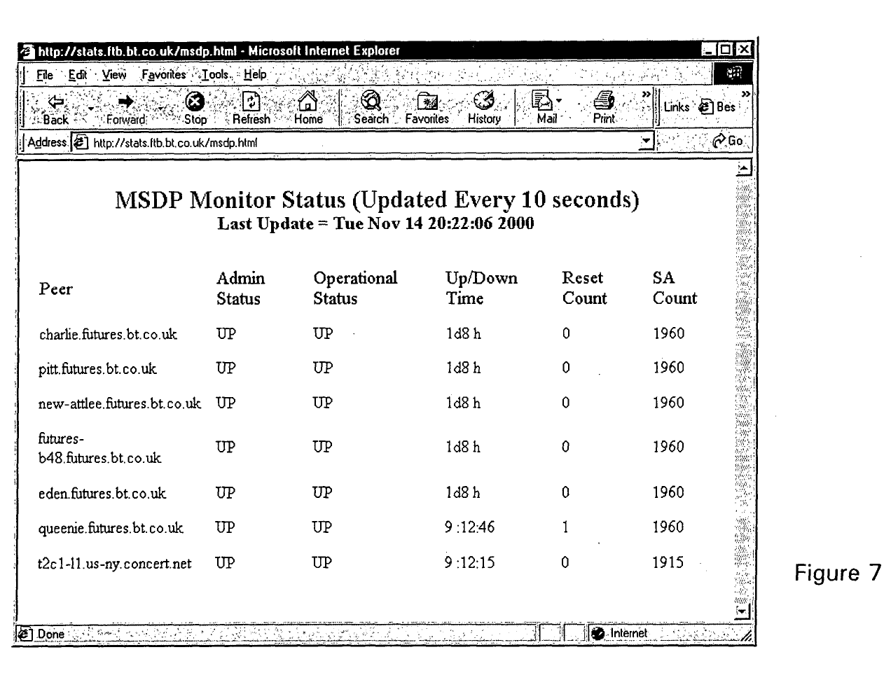

FIG. 7 is an illustration of an output display produced according to the embodiment of FIG. 4;

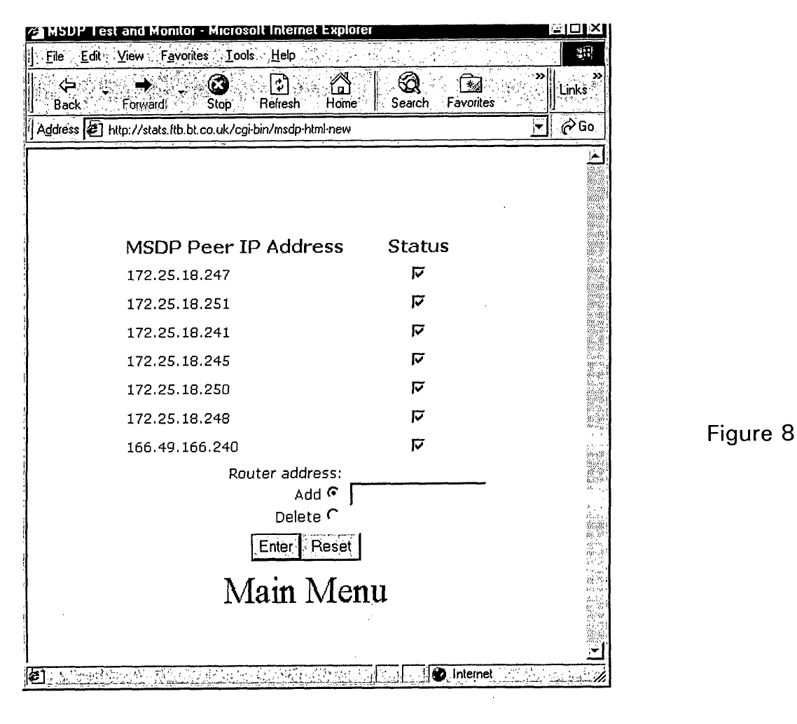

FIG. 8 is an illustration of an input display produced according to the embodiment of FIG. 4;

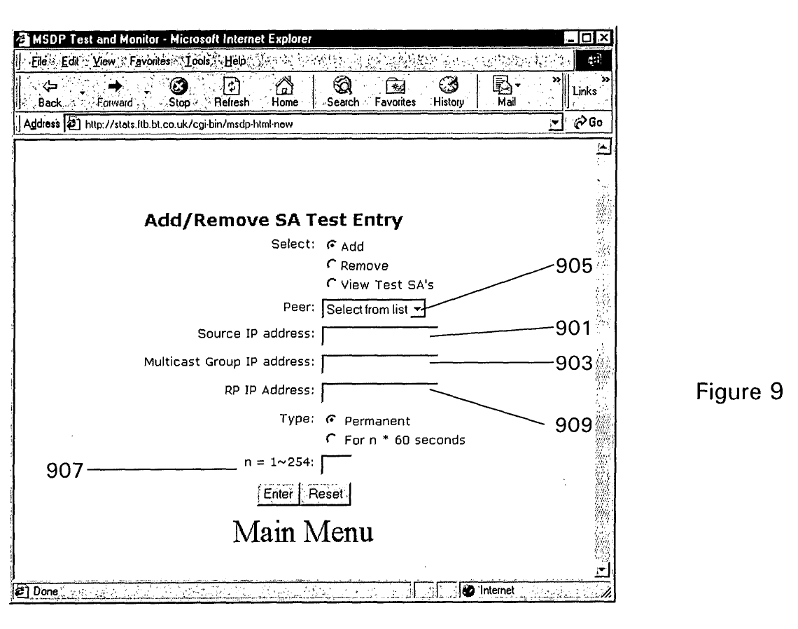

FIG. 9 is an illustration of a further input display produced according to the embodiment of FIG. 4;

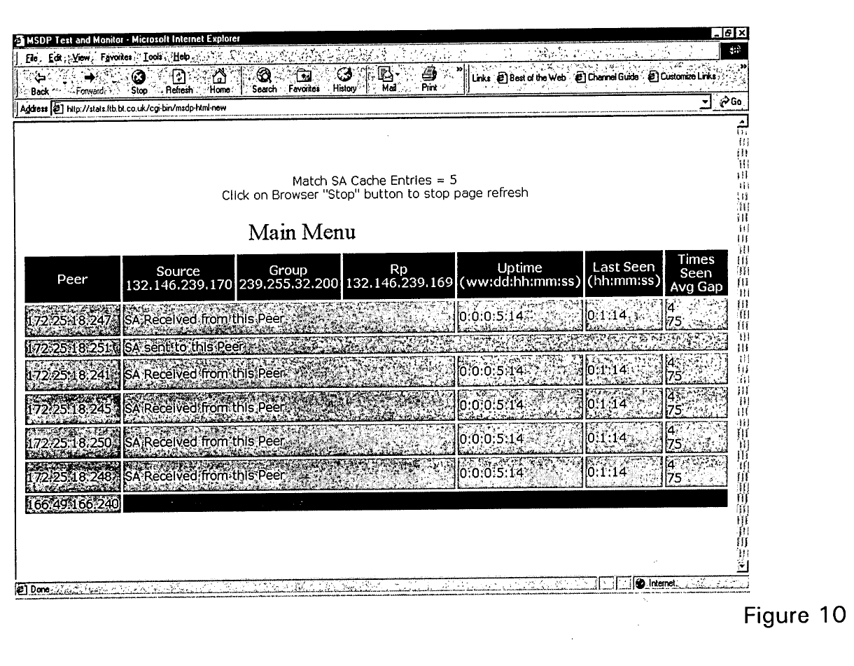

FIG. 10 is an illustration of a further output display produced according to the embodiment of FIG. 4;

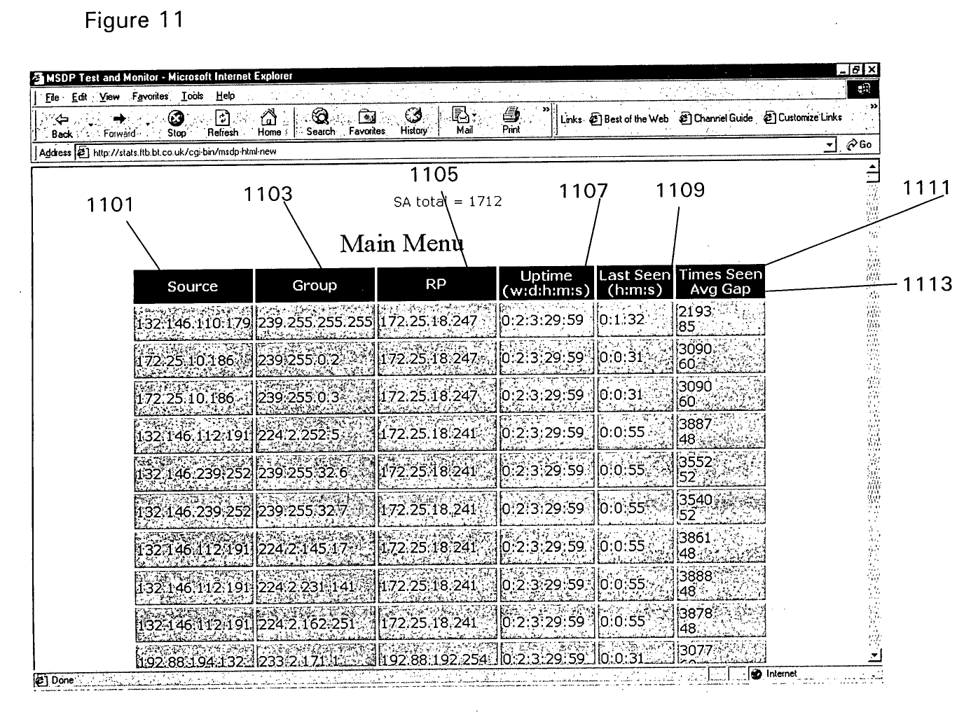

FIG. 11 is an illustration of another output display produced according to the embodiment of FIG. 4;

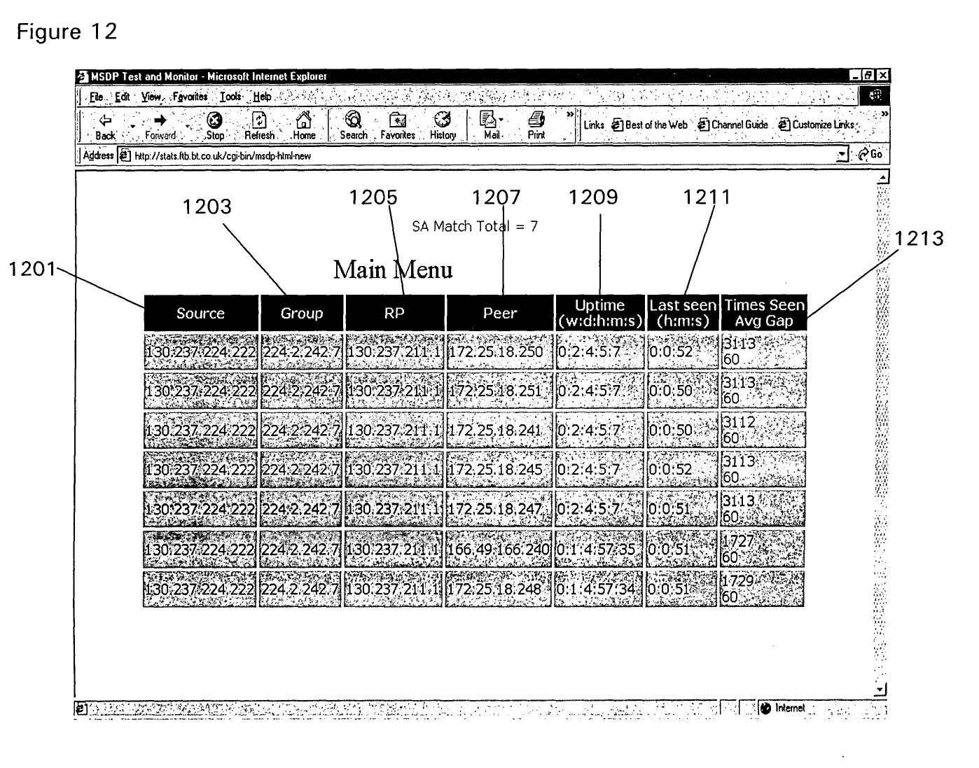

FIG. 12 is an illustration of yet another output display produced according to the embodiment of FIG. 4;

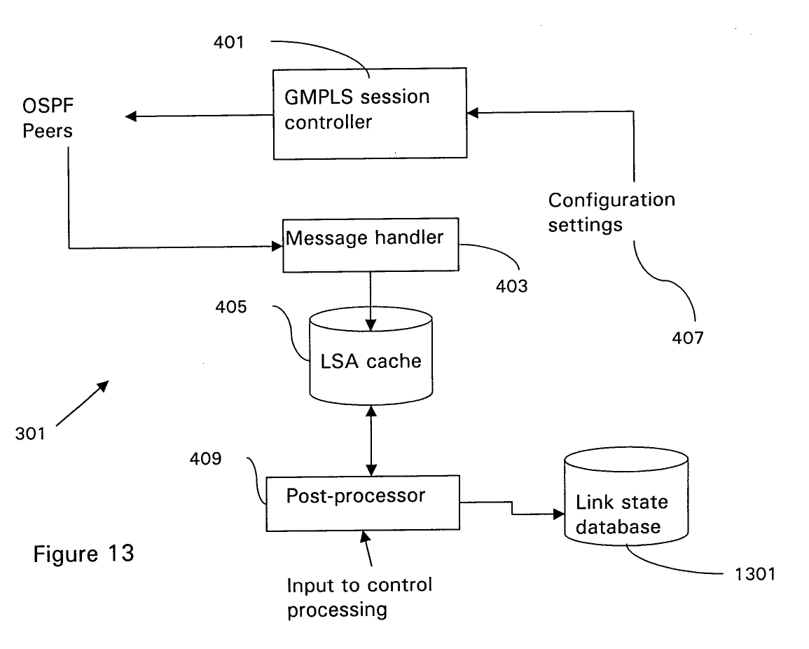

FIG. 13 is a schematic block diagram showing a second embodiment of network management apparatus according to the invention; and

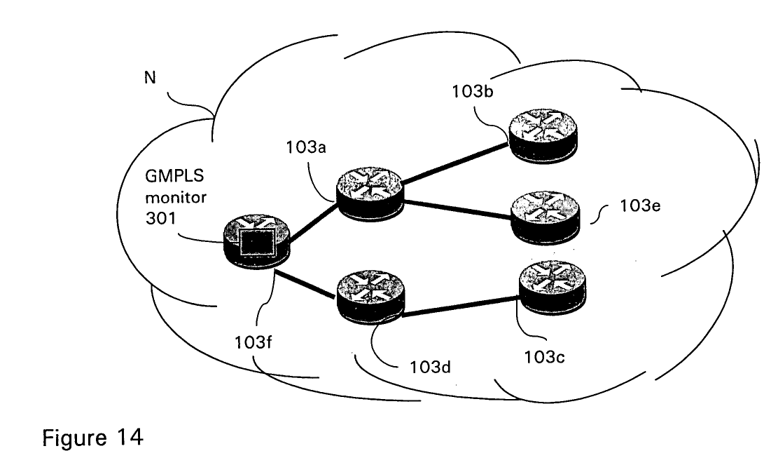

FIG. 14 is a schematic diagram showing an example of an operating environment for the second embodiment.

In the following description, the terms “device”, “keepalive messages”, “host”, “receiver” and “domain” are used. These are defined as follows:

“device”: any equipment that is attached to a network, including routers, switches, repeaters, hubs, clients, servers; the terms “node” and “device” are used interchangeably;

“keepalive”: Message sent by one network device to inform another network device that the virtual circuit between the two is still active;

“host”: equipment for processing applications, which equipment could be either server or client, and may also include a firewall machine. The terms host and end host are used interchangeably;

“receiver”: host that is receiving multicast packets (IP datagrams, ATM cells etc.); and

“domain”: a group of computers and devices on a network that are administered as a unit with common rules and procedures. For example, within the Internet, domains are defined by the IP address. All devices sharing a common part of the IP address are said to be in the same domain.

### Overview

FIG. 1 shows a typical configuration for a network transmitting multicast data using the PIM-SM (Protocol Independent Multicast—Sparse Mode) intra-domain protocol. Multicast content corresponding to multicast group address G1 is registered at a Rendezvous Point router (RP) 101, which is operable to connect senders S1 100 and receivers 105 of multicast content streams, using any IP routing protocol. Lines 107 indicate paths over which multicast content is transmitted. The mechanics of multicast request and delivery processes are known to those with ordinary skill in the art, and further details can be found in “Multicast Networking and Applications”, Kenneth Miller, published by Addison Wesley, 1999.

FIG. 2 shows a configuration for inter-domain multicast connectivity between a first domain D1 and a second domain D2, as provided by the Multicast Source Discovery Protocol (MSDP). As described with reference to FIG. 1, sender S1 100, located in the second domain D2, registers its content corresponding to multicast group address G1 at RP2, which distributes the content to requesting receivers 105. One of the receivers 105a in the first domain D1 registers a request for multicast content, via the Internet Group Messaging Protocol (IGMP), corresponding to group address G1. In accordance with PIM-SM protocol, a join request is transmitted from Designated Router (DR) 109 in the first domain D1 to the Rendezvous Point router RP1 of the first domain, where multicast content for the first domain D1 is registered and stored for onward transmission. Both of the Rendezvous Point routers RP1, RP2 are running MSDP, which means that multicast content that is registered at RP2 in the second domain D2 is broadcast to RP1 in the first domain D1 (and vice-versa) via a Source, Active (SA: unicast source address, multicast group address) message. These messages are stored in a-SA cache on the respective RP.

In the example shown in FIG. 2, a SA message corresponding to S1, G1 is registered and stored on RP1, which then knows that content corresponding to S1, G1 is available via RP2, and can issue a join request across the domains D1, D2. RP2 in response to the join request, then sends the content across the domain to RP1, which forwards this to the requesting receiver 105a, in accordance with the PIM-SM protocol. Routers that are enabled to run MSDP are always Rendezvous Point routers (RP) known as “peers”, and the process of advertising SA messages between peers is known as “peering”. Thus, RP1 and RP2 are both peers.

These SA messages are broadcast every 60 seconds to all MSDP peers with message transmission spread across the “broadcast” (periodic refresh) time to smooth out the delivery of SA messages. This, together with the fact that the number of MSDP peers and SA messages is continually increasing, means that monitoring the behaviour of MSDP peers and locating problems between peers is extremely difficult. As described earlier, typical network management tools, such as tools that gather data via SNMP, generate additional network traffic when probing devices; such tools could potentially probe each peer, but this would generate a proportionate amount of additional network traffic. Moreover, because the SA messages are broadcast every 60 seconds, in order to keep an accurate log of data stored on every peer, a probe could be sent to each peer every 60 seconds. This additionally presents serious scalability issues.

### Overview of MSDP Monitor

FIG. 3 shows a first embodiment of the invention, generally referred to as MSDP Monitor 301, acting as a peer, located in a Local Area Network (LAN), peering with several RP 303a-g that are also peers.

FIG. 4 shows the basic components of the MSDP Monitor 301: Configuration settings 407 are input to MSDP session controller 401, which controls TCP sessions and MSDP peering between the Monitor 301 and other peers. The configuration settings 407 include identification of network addresses of peers that the Monitor 301 is to communicate with, and the type of data that the Monitor 301 should send to the peers. As the Monitor 301 is seen by all of the other peers in the network 303a-g as another peer, the Monitor 301 will be sent broadcasts of SA messages from each of these peers 303a-g. These messages are received by message handler 403 for parsing and storing in a SA cache 405. A post-processor 409 accesses the SA cache 405 and processes the data in the SA cache 405 in accordance with a plurality of predetermined criteria that can be input manually or via a configuration file.

MSDP monitors according to the present invention are therefore regarded as conventional MSDP peers by other peers in the network. Advantages of this embodiment can readily be seen when the monitor 301 is compared with conventional network management tools. Firstly, there is a relative reduction in network traffic—the monitor 301 works on information contained in SA messages that have been broadcast between peers and are therefore already in the network. Thus the monitor 301 does not need to probe MSDP peers, and does not generate any additional network traffic for the purposes of network monitoring and testing outside of the MSDP protocol.

Further advantages result from specific features of the MSDP monitors of the invention, such as the way in which events are scheduled within the monitor 301. For example, changes can be made to peering events—e.g. peers can be added, deleted, made active or shutdown—without affecting other peering sessions. The scheduling aspects of the monitor 301 ensure that changes to peering status and/or real SA messages are controlled, thereby providing a predictable flow of events. Thus the monitor 301 is scalable.

Preferably, the monitor 301 can inject test SA messages into the network and track how peers in the network handle these messages. In one arrangement the monitor 301 itself appears to originate the test SA message, and in another arrangement the monitor 301 can make the test SA message appear to originate from another peer. This allows the monitor 301 to check forwarding rules in operation on the peers. The configuration settings 407 are flexible, so that the peer to which the test message is sent can be changed easily.

Events can be advantageously scheduled in relation to the processing of incoming SA messages. For example, the monitor 301 schedules MSDP session events, taking into account SA messages that are broadcast to the monitor 301, so that if the monitor 301 makes a change to an existing peering session, this change is synchronised with any incoming SA messages. In order to account for size variation of incoming SA messages, the monitor 301 can be configured to read a maximum message size from the inbound buffers (e.g. 5 KB), which evens out inter-cycle processing times, resulting in a reduced amount of jitter.

In addition, the processing of MSDP session events is decoupled from the analysis of incoming SA messages and changes in configuration settings. This enables identification of information such as router policy rules; SA broadcast frequency; forwarding rules; number of sources transmitting content corresponding to a particular multicast group address; number of source addresses that are registered at each RP, which provides an indication of the distribution of multicast content, and general message delivery reliability and transit times across the network.

The features that realise these advantages are described in detail below.

As stated above, the session controller 401 sets up MSDP peering sessions with other MSDP peers in accordance with configuration settings 407. These configuration settings 407 include network addresses of RP to peer with, status of peerings, and SA messages to send to peers. These configuration settings 407 can be set automatically or manually, via a user interface, as is described in more detail below.

Once the session controller 401 has received new, or modified configuration settings 407, the session controller 401 activates a new MSDP session or modifies an existing MSDP session accordingly. As is known to those with ordinary skill in the art, MSDP is a connection-oriented protocol, which means that a transmission path, via TCP, has to be created before a RP can peer with another RP. This is generally done using sockets, in accordance with conventional TCP management. Thus when the MSDP Session Controller 401 receives an instruction to start an MSDP peering session with a specified RP, the session controller 401 firstly establishes a TCP connection with that specified RP. Once the TCP connection has been established, SA messages can be transmitted via the TCP connection, and the monitor 301 is said to be “peering” with the peer (specified RP). If an MSDP message is not received from a peer within a certain period of time (e.g. 90 seconds), the monitor 301 automatically shuts down the session.

Once an MSDP session has started between peers, and while a SA message is live (i.e. the source S1 is still registering the content at its local RP), the RP will advertise the SA in an MSDP SA message every 60 seconds. Thus peers receive SA messages once every 60 seconds while the source S1 is live. Peers timestamp the SA message when it is received and save the message as an SA entry in their respective SA cache. When the SA entry expires in the multicast routing state on the RP, say because the source S1 is shutdown, the SA message is no longer advertised from the RP to its peers. Peers check the timestamp on messages in the SA cache and delete entries that have a timestamp older than X minutes (X is configurable).

As described above, arrangements of the monitor 301 involve the monitor 301 peering with other MSDP peers, and as such the monitor 301 looks as if it is another peer to the other RP that are receiving and transmitting MSDP messages. MSDP rules on cache refreshing are defined at http://www.ietf.org/internet-drafts/draft-ietf-msdp-spec-06.txt. In order for the monitor 301 to maintain MSDP sessions with these other peers, it has to send either a SA message or a keepalive message to these peers at least once every 90 seconds.

The monitor 301 operates in at least two modes:

1) Monitoring treatment of SA messages by peers: the objective is to determine which SA messages are received and stored by peers. As described above, in order for the monitor 301 to maintain MSDP sessions with peers, it has to transmit messages to the peers. However, in this mode of operation the monitor 301 does not want to send “real” SA messages, so the session controller 401 sends “keepalive” messages instead;

2) Testing progression of SA messages between peers: the objective is to determine how SA messages are distributed between peers, so the session controller 401 sends “real” SA messages corresponding to a unicast source address and multicast group address specified in the configuration settings 407.

Thus the monitor 301 receives and sends a variety of messages. This sending and receiving of messages, and the handling of various events that comprise or are spawned from the messages, requires scheduling, in order to ensure coherent operation of the monitor 301. For example, the handling of incoming SA messages, which can be received from peers at any time, and operation of the session controller 401, which has to make changes to existing sessions, initiate new sessions and broadcast SA messages in accordance with the configuration settings 407, have to be controlled. Furthermore, inbound buffers, which are inbound storage areas comprising information received from a remote peer on a specified socket, have to be serviced (e.g. writing to SA cache 405) and the information contained therein has to be post processed (as described in more detail below), in order to gather information from the testing and monitoring processes, and this has to be accounted for in the scheduling process.

FIGS. 5a and 5b, in combination, show an example scheduling process according to the first embodiment, which combines processing of various periodic events with servicing of inbound buffers that contain SA messages. The schedule operates as an “infinite” loop, which repeatedly performs certain checks and operations until the loop is broken in some manner (infinite loops are well known to those skilled in the art). The schedule is designed to provide as much time as possible to service inbound buffers. In the Figures, events relating to actions of the session controller 401 are in normal font, and events relating to servicing inbound buffers and post-processing of the SA cache are in italics (and discussed later).

ENTER LOOP:

Step S5.1: Is it time to check whether there are any changes to the status of peers? This time is set to loop every 10 seconds, so that if 10 seconds has passed since the last time S5.1 was processed, then the condition will be satisfied. Note that this time is configurable and could be anything from 1 second to 600 seconds. Zero may also be specified and is a special case that has the effect of automatically disabling a check on peer status. This can be used where the administrator requires a strict control of peering. If Y Goto S5.2, else Goto S5.3;

Step S5.2: Read configuration settings 407: the session controller 401 reads a list of peers (number of peers=n) together with a status flag (either operational or down) against each peer, noting any changes to the list of peers—i.e. addition of new peers, or changes to status flags against peers that are already on the list. If a new peer is added to the list, with status flag set to operational, this indicates that a new session is to be started with that peer; this is handled at steps S5.10-S5.11. If a status flag is set to down, this indicates that the corresponding session is to be stopped, and the session controller 401 shuts down the respective existing TCP session at this point (closes corresponding socket). In one arrangement of the monitor 301, “shutting down” involves ending the MSDP session, but leaving the peer on the list of peers (with status flag set to “down”). In this arrangement, the SA cache is cleared for this peer, but other data that has been maintained for the peer, such as timers and counters, are stored (e.g. for use if that peering session were to be restarted). Alternatively, in addition to “shutting down” the MSDP session, the peer could be removed from the list, resulting in deletion of all information collected in respect of the peer.

Steps S5.3-S5.6: Post-processing activities—see below;

Step S5.7: Is it time to check for any changes to outgoing SA messages? If Y Goto S5.8, else S5.9;

Step S5.8: Read configuration settings 407 relating to test SA messages and process actions in respect of the test SA messages. These test SA settings detail the nature of a test SA message, together with an action to be performed in respect of that message—i.e. add, delete or advertise SA messages to some, or all, peers in the list of peers; Goto S5.9

Step S5.9: Access the list of peers, for first peer in list set peer counter i=0.;

Step S5.10: Is i<n? If Y, Goto S5.1, If N, Check whether peer i is down and whether the status flag corresponding to this peer indicates that peer i should be operational. This combination (peer down, status flag operational) can arise in two situations—firstly if a new peer has been added to the list of peers, and secondly if there has been a problem with peer i—e.g. the router has stopped working for any reason. If the status flag indicates that peer i should be up, Goto S5.11;

Step S5.11: Try to (re)start the MSDP session with peer i by opening a TCP socket for connection with peer i;

Step S5.12: Check whether a message has been received from peer i in the last 90 seconds. This involves checking an internally maintained timestamp associated with keepalive messages for peer i. The timestamp will be less than 90 seconds old if the peering is active (see below). If N Goto S5.13, else Goto S5.14

Step S5.13: Close the socket opened at S5.11 and Goto S5.14;

Step S5.14: If message has been received at S5.12 then peer i is up operationally, Goto S5.16. If peer i is down operationally, Goto S5.15;

Step S5.15: Increment i and move to the next peer on the list; Goto S5.10;

Step S5.16: Carry out some post-processing (see below) and send keepalive messages to peer i if no real SA messages were sent to peer i at S5.8 (i.e. monitor 301 not in testing mode). Goto S5.15.

The post-processing carried out at Step S5.16 involves reading the inbound buffer corresponding to peer i, which comprises information received from the peer i stored on the corresponding inbound socket by the operating system. This information can be one of five valid message types (e.g. SA, SA request, SA response, Keepalive or Notification messages), and the data handler 403 is responsible for reading the information and processing it:

SA: SA messages contain the information about active S,G pairs and make up the majority of messages received; valid SA messages are stored in the SA cache 405 (these are the message type that are processed by the post processor 409). SA messages comprise RP address, Source address and Group address;

SA request and SA response: These are only used by non-caching MSDP routers. The monitor 301, and virtually all MSDP routers in the Internet, is of the caching type, so these messages almost never get used. The monitor logs these 301 messages as these indicate non caching MSDP routers or routers with requesting receivers but no active sources;

Keepalive messages: These are used to reset a received keepalive timestamp for a peer;

Notification messages: These are used to inform a peer of a particular problem e.g. bad message types, bad source addresses, looping SA messages. On receipt of a notification message with a specific bit set, the corresponding MSDP peering session is reset.

By default each inbound buffer is 65 KB in size (although this can vary with operating system on which the monitor 301 is run) so the time taken to process 0>65 KB per peer can cause several seconds difference in processing all of the inbound buffers between cycles (especially when run on different platforms or running other tasks). In an attempt to balance inter-cycle processing times, and thus reduce jitter, the data handler 403 can be configured to read a maximum message size from the inbound buffers (e.g. 5 KB).

The data handler 403 stores the information per peer:

struct msdp_router {

| | |
|---|---|
| char router[25]; | /* IP address of MSDP Peer */ |
| unsigned char mis_buf[12]; | /* Temp. buffer to store SA fragments */ |
| int soc; | /* pointer to TCP socket */ |
| time_t R_keepalive; | /* Receive Keepalive, time since last input from peer */ |
| time_t S_keepalive; | /* Send Keepalive, time since we last sent a packet to the |
| | peer */ |
| time_t up_time; | /* Time since last UP/Down transition */ |
| int status; | /* Operational Peer Status, 1= =UP 0= =down */ |
| int admin_status; | /* Admin Status of Peer, 1= =Enable, 0= =Disable */ |
| int match; | /* Temp. flag used in searches */ |
| int sa_count; | /* Number of valid SA messages from Peer currently in Cache |
| | */ |
| int frag; | /* Fragmentation flag, 1= =process fragment, 0= =new packet */ |
| int data; | /* Flag to show that additional bytes received = = data, so drop |
| | them*/ |
| int stub; | /* Flag to denote processing a very short SA fragment > 8 |
| | bytes */ |
| unsigned int missing_data; | /* Counter to track the number of bytes missing in fragment */ |
| unsigned int offset; | /* TCP data segment offset, point to start processing from */ |
| unsigned int reset_count; | /* Number of UP/Down transitions */ |
| int swt_frg; | /* Retain MSDP packet type ID, so fragment handled |
| | correctly */ |
| int cnt; | /* Remember the number of outstanding SA's for this RP |
| | between fragments */ |
| unsigned long int rp; | /* Temp storage of RP address between fragments */ |

};

The data handler 403 then places the following information in the SA cache

405:
struct msdp_sa {

| | |
|---|---|
| unsigned long int peer; | /* MSDP Peer IP address: peer from which the |
| | SA message was received */ |
| unsigned long int rp; | /* RP address for this S,G pair */ |
| unsigned long int source; | /* Source address */ |
| unsigned long int group; | /* Group address */ |
| unsigned long int count; | /* counter = number of times SA received */ |
| time_t first; | /* Timestamp: time entry first received */ |
| time_t last; | /* Timestamp: time entry last received */ |

};

Referring back to FIG. 5, steps S5.3 and S5.4, which trigger post-processing of the SA cache 405 and are run periodically (nominally every 10 seconds), comprise writing the SA cache 405 to a file. Steps S5.5 and S5.6, which are also run periodically, comprise reading data from the file populated at S5.4, evaluating the read data and creating a web page, as is described below with reference to FIGS. 7, 10, 11 and 12.

In conventional MSDP routing of SA messages, forwarding checks are performed on incoming messages at each peer to prevent flooding the network with multiple copies of the same SA messages and to prevent message looping. This can be done by forming a mesh between MSDP peers, as shown in FIG. 6a, so that, for peers within a mesh, SA messages are only forwarded from the originating peer to each of the other peers in the mesh. Alternatively, incoming SA messages are sent out of every interface of every peer (except the interface at which the SA messages was received), and peers then independently perform Reverse Path Forwarding (RPF) analysis on the messages, as shown in FIG. 6b.

Each mesh operates independently of any other meshes that may be in operation in the network. In one arrangement, the monitor 301 itself forms a single mesh. As a result, all of the SA messages broadcast from each of the peers 303a-g are forwarded to the monitor 301, as shown in FIG. 3, and potentially none of the SA messages are deleted prior to storing in the SA cache 405. FIG. 7 shows one of the web pages created at S5.6. The right hand field, “SA count” details the number of SA messages that have been received from the peer detailed in the left hand column. As incoming messages have not been processed for duplicates, this field provides information about how the peers are handling SA messages: if all of the peers were handling the messages identically, then an identical SA count would be expected for all peers. However, as can be seen from FIG. 7, the last peer in the list, t2c1-l1.us-ny.concert.net is broadcasting fewer SA messages than the other peers. This indicates that this peer may be applying some sort of filter to block incoming SA messages, blocking outbound SA messages, or that SA messages have been blocked at a previous point in the network. One of the advantages of the invention is thus that additional information, such as peering policy, can be mined from the raw data received by the monitor 301. In this case, the advantage results from the fact that the monitor 301 forms a mesh comprising itself only and therefore does not automatically remove duplicate SA messages.

The post-processor 409 could also include a detecting program 411 for detecting abnormal multicast activity. Many known systems attempt to detect malicious attacks on the network. Typically these systems utilise static thresholds and compare numbers of incoming data packets, or the rate at which data packets are received, with the static thresholds. However, a problem with this approach is that it is difficult to distinguish between an increased volume of traffic relating to an increase in genuine usage and an increased volume of traffic relating to a malicious attack (e.g. flooding the network with packets). With no means of differentiating between the two, genuine multicast data can be incorrectly discarded.

In an attempt to overcome these problems, the detecting program 411 evaluates, during the post-processing step generally referred to as S 5.4, (a) number of groups per Source Address, (b) number of groups per RP and, (c) for each peer, number of SA messages transmitted therefrom, and calculates changes in average numbers (for each of a, b, c). If the rate of change of average numbers exceeds a predetermined threshold, it generates an alert message.

As an addition, or an alternative, the detecting program 411 is arranged to compare the evaluated numbers with predetermined maximum, minimum and average values (for each of a, b and c) and to generate an alert message should the evaluated maximum and/or minimum numbers exceed their respective predetermined thresholds. The skilled person will appreciate that other combinations, such as rate of change of maximum and/or minimum can be used to decide whether or not an alert should be generated.

In one arrangement, the thresholds could be determined by a neural network, arranged in operative association with the detecting program 411. The neural network could be trained using numbers corresponding to, e.g., number of groups per Source Address (considering (a) above) that have been received during periods of genuine usage, and numbers of the same that have been received during periods of malicious usage. The neural network can have several output nodes, one of which corresponds to genuine usage, one of which corresponds to malicious usage, and at least one other that corresponds to unknown behaviour that could require further investigation. The thresholds would then be provided by output nodes corresponding to malicious and unknown behaviour, and an alarm would be generated in the event that incoming data triggers either of these output nodes. The neural network would be similarly trained and utilised for incoming data corresponding to (b) number of groups per RP and (c) number of SA messages transmitted from each peer.

Thus with known systems, an alarm is generated when a threshold is violated, meaning that Y messages are randomly dropped. With the detecting program 411, however, behaviour patterns are detected, and incoming data is categorized as a function of Source address, peer address and RP, so that the detecting program 411 can generate alarms of the form “threshold violated due to device 1.1.1.1 generating z messages”. This effectively “ring fences” the problem, allowing other valid MSDP states to be forwarded without being dropped.

If the MSDP monitor 301 is running in association with the Unix Operating System, the alert message can be a syslog message, which is stored in directory /var/admin/messages. These syslog messages are then accessable by another program (not shown) for setting filtering policies on network devices.

FIG. 9 shows an interface that can be used to input “real” SA messages: the source and group addresses 901, 903 of the SA message to be broadcast can be specified, together with an IP address of a target peer 905 and a time for broadcasting the message 907. Note that when this time expires the corresponding SA message is deleted from the configuration settings 407 during the next processing cycle of step S5.8. The target peer 905 is the peer that the session controller 401 actually broadcasts the test SA message to. This input is then stored as a structure for reading by the session controller 401:

struct sa_local {

| | |
|---|---|
| unsigned long int peer; | /* MSDP Peer IP address, the peer the SA is sent to */ |
| unsigned long int source; | /* Source address */ |
| unsigned long int group; | /* Group address */ |
| unsigned long int rp; | /* RP address */ |
| unsigned long int life; | /* Specify time period SA is advertised: 0= =for ever 1-n = = |
| | time period */ |
| int match; | /* Temp. flag used in searches etc . . . */ |
| time_t start; | /* Timestamp: time SA was generated */ |
| time_t last; | /* Timestamp: time SA was last announced */ |

};

In addition the user can specify an IP address of a RP 909 from which the test message “appears” to originate (i.e. the test SA message appears to originate from a RP other than the monitor 301). This is useful when testing for loops between peers (i.e. for checking that the peers are operating RPF correctly, or that the mesh group is operating as expected). For example, consider the following arrangement: R1 [symbol] R2 [symbol] R3 [symbol] Monitor 301

where [symbol] indicates a TCP MSDP connection between devices, and R1, R2 and R3 are MSDP enabled RP routers. If the session controller 401 sends a test SA message to R3 using the IP address of R2 for the RP of the SA message, and if R3 regards the monitor 301 as a non mesh-group peer, R3 would be expected to drop the test message (i.e. under RPF R3 will not broadcast an SA message to a peer if it determines, via its routing tables, that this message was received from an unexpected peering. For the example, R3 receives an SA with the RP address equal to R2 but the message was actually received from the controller 401. R3 determines that this is wrong, so the message is dropped). If the monitor 301 is configured in mesh-group A and R1, R2, & R3 are configured as mesh-group B, then whatever the characteristics of the test SA message sent from the session controller 401, the test message would be expected to be broadcast from R3 to R2 (recall that packets are not subject to RPF checks in mesh groups). Note that R3 would never be expected to send the SA back to the monitor 301.

As stated above, other advantages of the embodiment result from de-coupling the processing of data (post processor) from the operation of the session controller 401. For example, when the session controller 401 is sending test SA messages in accordance with the configuration settings input via the GUI shown in FIG. 9, the post processor 409 can be triggered to examine (step S5.4) the SA cache 405 for the presence of SA messages corresponding to the SA test message, and note which peers are broadcasting this to the monitor 301. This information can then be displayed graphically (step S5.6), for example as shown in FIG. 10. This information is useful as it helps to determine whether SA messages are being correctly forwarded across the network. A failure to receive an SA message back from a peer may be due to a configuration issue by design or error, the network topology or peering policy. The data shown in FIG. 10 relates to the network arrangement shown in FIG. 3, and shows that the SA message was successfully sent to 172.25.18.251. The fact that all other 172.25.18.* peers successfully returned the message back to the monitor 301 indicates that 172.25.18.251 forwarded the SA message on without problems. As a message was not received from 166.49.166.240 this indicates that configuration or policy issues on either 172.25.18.251 or 166.49.166.240 prevented the message from being forwarded.

In one arrangement, the post processor 409 evaluates (step S5.4) the number of unique SA messages broadcast to the monitor 301. This can be viewed graphically (step S5.6) as shown in FIG. 11, which shows source address 1101, multicast group address 1103, RP 1105 (i.e. the IP address of the router generating the SA message), the total uptime for SA message 1107, time SA message last seen 1109 (time of most recently received SA message), the number of times each SA message has been received 1111 and the average time gap between SA messages 1113. The average gap 1113 can be determined by evaluating the following:

$$Av gap = \frac{\begin{matrix}Time of most recently received SA message - \\ Time SA message first received\end{matrix}}{Number of times SA message seen}$$

If a peer were broadcasting SA messages in accordance with MSDP standard, this time would be expected to be 60 seconds. However, as can be seen in several of the columns in FIG. 11, some of the average gap times are less than 60 seconds, which could indicate, e.g. a peer is broadcasting more than one SA message. This further illustrates one of the advantages of the invention, which, as described above, is the combination of collecting a rich supply of raw data and processing the raw data independently of the collection process. This allows the raw data to be analysed for additional information, such as broadcast frequency of SA messages, which is otherwise extremely difficult to obtain.

Other information that can be mined from the raw cache data includes:

identifying which SA messages were not broadcast and from which peers the messages were not broadcast (referring to RH column of FIG. 7);

identifying how many sources are transmitting content corresponding to a particular multicast group address; and

identifying the number of source addresses that are registered at each RP, which provides an indication of the distribution of multicast content (and can highlight potential congestion problems).

In addition, information relating to individual SA messages can be extracted at step S5.4. Referring to FIG. 12, for a specified source and group address 1201, 1203, the RP 1205 at which the content is registered (recall that each SA message includes the RP at which the corresponding multicast content is registered), and the peers 1207 to which that RP broadcast an SA message corresponding to this content, can be identified, together with the total time 1209, and the last time 1211, that the SA message was broadcast from respective peers to the monitor 301. As with FIG. 11, the average time can be evaluated and is shown in the right hand column 1213 of FIG. 12. The information shown in FIG. 12 is useful as it provides an indication of message delivery reliability and transit times across the network.

In another embodiment, the MSDP monitor 301 can be arranged to function as a server, thereby actively controlling distribution of SA messages between domains. In this way the monitor 301 acts as a demarcation point and provides bi-directional control of the flow of SA messages, so that all MSDP SA messages exchanged between domains A and B are controlled by the server.

E.g. domain A ----- MSDP monitor/server 301 ----- domain B

When configured as a server, the monitor 301 can explicitly control message scheduling. In addition, filtering policies can be distributed to the monitor 301, which enables remote control thereof from a centralized processor, enabling efficient re-use of policy rules. Furthermore MSDP mesh configurations, such as those described above with reference to FIG. 6a, can be simplified.

Thus, in a distributed network comprising a plurality of MSDP monitors 301, some could perform monitoring functions, some could control SA distribution (i.e. act as a server), and some could perform a mixture of monitoring and control functions (i.e. act as a hybrid monitor and server).

### Implementation Details

As described above, the configuration settings 407 can be modified manually, preferably with authentication of the user making the modifications. In one arrangement the user inputs a username and password to a TACAS server, which can then verify the login credentials via either static password files or by token authentication such as Security Dynamics SecurID, as is well known to those of ordinary skill in the art. Once the user has been authenticated he can modify the configuration settings 407 via a GUI, such as those shown in FIGS. 8 and 9. Possible changes include adding peers, changing the status of an existing peer (FIG. 8), and defining an SA message to be broadcast to other peers (FIG. 9). Note that once changes have been made to the configuration settings 407, the settings are written to a file. File locking is used to eliminate data corruption while changes are taking place, thereby ensuring that only one change can be made at a time.

The configuration settings 407 essentially comprise input and output files files. Input files are populated with input from the user (e.g. via FIGS. 7 and 9 as described above)—msdp.hosts is a file that comprises list of peers and their status and msdp.test is file that comprises details of SA test messages. Output files are populated with output from various operations of the session controller 401 and data handler 403—msdp.data is a file that is populated at step S5.4 and msdp.html is an html file that is populated with data from msdp.data (step S5.6). The configuration settings 407 additionally include a configuration file (msdp.conf), which details the location of such files, and is read by the monitor 301 during initialisation. This allows the programs and the output files to be placed in any suitable directory on the system.

Example configuration file-msdp.conf:

```
# THIS CONFIG FILE SHOULD BE LOCATED IN THE /etc DIRECTORY
# The peer:, sa:, summary:, test: and invalid: tags are optional and used to set the
# interval between periodic events.
# peer: determines the interval between reading the msdp.hosts file, range is 0˜300 seconds
# sa: determines frequency at which the msdp.data file is updated, range is 1˜600 seconds
# summary: frequency at which the msdp.html file is updated, range is 1˜600 seconds
# test: interval between reading msdp.test file and sending (if required) SA messages, range 1˜60 sec
# invalid: determines how old SA messages need to be before they are deleted from SA cache, range
# is 6 minutes to 90 days specified in seconds
data:
/home/barretma/
enddata:
html:
. . . /
endhtml:
peer:
  10
endpeer:
sa:
  10
endsa:
summary:
  10
endsummary:
test:
  10
endtest:
invalid:
360
endinvalid:
```

### Second Embodiment

In a second embodiment of the invention, the idea of peering with network devices in order to gather information is applied to GMPLS (Generalised Multi Protocol Label Switching). GMPLS is designed to extend IP routing and control protocols to a wider range of devices (not just IP routers), including optical cross connects working with fibres and wavelengths (lambdas) and TDM transmission systems such as SONET/SDH. This allows networks, which today use a number of discrete signalling and control layers and protocols (IP, ATM, SONET/SDH), to be controlled by a unified IP control plane based on GMPLS.

A link refers to a data communications link or media (e.g. Ethernet, FDDI, frame relay) to which the router or other device is connected (linking it to one or more other routers). With GMPLS, IP routing protocols are enriched to capture the characteristics and state of new link types such as optical wavelengths, fibres or TDM slots. Information relating to the new link type is needed to allow an IP routing protocol to support appropriate control and routing functions for these new link types. The IP routing protocols enriched and used for this purpose are called Interior Gateway Protocols (IGPs) the most common being OSPF and IS-IS (Intermediate System to Intermediate System).

These protocols (OSPF, IS-IS) work in a similar way to MSDP. Link state advertisements (LSA) are flooded between routers that have a peer relationship. Each peer running OSPF builds a link state database from this information, which provides a representation of the network topology and attributes (such as cost/bandwidth) for individual links. The peer uses this database to perform calculations such as deriving the shortest path to all destinations on the network to populate its routing table and forward packets.

However, as these protocols (OSPF, IS-IS) are interior gateway protocols, the peers in the second embodiment send information within a domain, rather than, in the case of MSDP, inter-domain.

Aspects of the second embodiment are now discussed with reference to FIGS. 13 and 14, where parts and steps that are similar to those described in the first embodiment have been given like reference numerals, and are not discussed further.

FIG. 13 shows the basic components of the GMPLS Monitor 301: Configuration settings 407 are input to GMPLS session controller 401, which controls TCP/IP sessions and OSPF peering between the GMPLS Monitor 301 and other peers. The configuration settings 407 include identification of network addresses of peers that the Monitor 301 is to communicate with, and the type of data that the Monitor 301 should send to the peers.

The GMPLS monitor 301 can peer with one peer, or with many peers. The peering strategy employed by the GMPLS monitor 301 (one-to-one, or one-to-many) is dependent on the peering protocol—here OSPF. As is known to one skilled in the art, and referring to FIG. 14, OSPF works by exchanging messages contained in IP packets between each router 103a-103g running the protocol. Each router 103a generates information, known as link state adverts (LSAs), about links that it is directly connected to and sends them to all of its peers 103b, 103e. LSAs received from other peers are also passed on in a similar way so they reach every other router running OSPF. These messages are stored in a LSA cache 405 on the respective router 103a, 103b. Each router then performs a calculation using the LSAs that it receives to determine the shortest path to all destinations on the network, and uses this as the basis for packet forwarding. With GMPLS, the OSPF protocol also includes information relating to optical wavelengths, fibres or TDM slots.

Thus, peering to any OSPF router should provide ALL link state adverts that originate within the network N. So if the configuration settings 407 indicate that LSA content is required, the GMPLS monitor 301 only needs to peer with one peer 103a. However, if the configuration settings 407 indicate that aspects of the peer forwarding process within the network N are to be assessed, the GMPLS monitor 301 peers with several, or all, peers 103a-g.

As is known in the art, when a link fails, routers connected to the failed link send out a LSA telling all other OSPF routers the link has failed. There is a finite period before this advert is received by other routers, whereupon they can recalculate new routes around the failure. During this period routing information in the network is incorrect and packets may be lost. Convergence is the process of reestablishing a stable routing state when something changes—e.g. a link fails. Once a link fails the routing protocol enters an unstable state where new link state information is exchanged and routes calculated until a new stable state is found.

As for the first embodiment, the post-processor 409 accesses the LSA cache 405 and processes data in the LSA cache 405 in accordance with a plurality of predetermined criteria that can be input manually or automatically via a configuration file. In one arrangement, the post processor 409 filters and evaluates the number of unique LSA messages broadcast to the monitor 301, creating a Link state database 1301. The Link state database 1301 can then be used as a diagnostic tool to evaluate the stability and convergence characteristics of the protocol for the particular links being used. As the LSA include information relating to new links, namely optical wavelengths, fibres or TDM slots, this information is also stored in the link state database 1301, which means that the GMPLS monitor 301 can evaluate stability and convergence of these new links. In addition, the status of links and routers, and the metrics utilized for IP routing (determined by routing algorithms running on the router), can be derived by reviewing historical data in the database.

Information in the Link state database 1301 can be displayed graphically, preferably as a web page, as described above with reference to step S5.6.

Many modifications and variations fall within the scope of the invention, which is intended to cover all permutations and combinations of the individual modes of operation of the various network monitors described herein.

As will be understood by those skilled in the art, the invention described above may be embodied in one or more computer programs. These programmes can be contained on various transmission and/or storage mediums such as a floppy disc, CD-ROM, or magnetic tape so that the programmes can be loaded onto one or more general purpose computers or could be downloaded over a computer network using a suitable transmission medium.

Unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

1. A router (RP1) for analysing distribution of multicast data in a network, the router being configured to store data corresponding to a transmitting network device, the said data being indicative of the network address of the transmitting device and a group address corresponding to multicast data transmitted therefrom, the router additionally being configured to receive requests from other network devices for multicast data and comprising means to access the stored data to identify a network address of a transmitting device corresponding to such a received request, the identified network address being subsequently used to deliver multicast data corresponding to the request to the requesting network device,
the router (RP1) also being arranged to receive and store a router message (SA) from another router (RP2), the router message (SA) comprising data indicative of a network address of a transmitting network device (S1), a group address (G1) corresponding to multicast data transmitted therefrom and a network address of the other router (RP2), the said data having been stored by the other router (RP2),
characterised by
input means arranged to receive input (407) identifying at least one other router (RP2);
triggering means (401) arranged to send a signal for triggering transmission of router messages from the or each identified router (RP2) to the said router (RP1); and
analysing means (409) arranged to analyse router messages received from the identified router(s) so as to ascertain distribution of multicast data (S1):

2. A router according to claim 1, wherein the analysing means is arranged to group the received router messages in accordance with group address so as to identify, for each group address, which, if any, of the identified routers is not distributing router messages corresponding to the group address.

3. A router according to claim 1 or claim 2, wherein the analysing means is arranged to ascertain from which of the identified routers the router message was received and to Identify a time of receipt thereof.

4. A router according to claim 3, wherein the analysing means is arranged to calculate, for a specified group address, an average gap between instances of receipt of router messages from the identified router corresponding to the specified group address.

5. A router according to any one of the preceding claims, wherein the analysing means is arranged to group the received router messages in accordance with the network address of transmitting network device, and, for each network address, the analysing means is arranged
to evaluate a rate of change of average number of received messages corresponding to the network address;
to compare the evaluated rate of change with a predetermined rate, and
if the evaluated rate of change exceeds the predetermined rate, to generate an alarm message.

6. A router according to any one of the preceding claims, wherein the analysing means is arranged to group the received router messages in accordance with the network address of the identified router from which the router message has been transmitted, and, for each network address, the analysing means is arranged
to evaluate a rate of change of average number of received messages;
to compare the evaluated rate of change with a predetermined rate, and
if the evaluated rate of change exceeds the predetermined rate, to generate an alarm message.

7. A router according to any one of the preceding claims, wherein the analysing means is arranged to group the received router messages into a plurality of groups in accordance with the network address of a router at which the multicast data has been stored on behalf of the transmitting network device, and, for each network address,
to evaluate a rate of change of average number of received messages;
to compare the evaluated rate of change with a predetermined rate, and
if the evaluated rate of change exceeds the predetermined rate, to generate an alarm message.

8. A router according to any one of the preceding claims, wherein the input means is arranged to receive input representative of test data to be transmitted by the router, the test data identifying a network address corresponding to a transmitting source of the test data, a group address corresponding to multicast data transmitted therefrom and a network address of a router at which the test data has been stored, the router being arranged to transmit one or more said test data to at least one of the identified routers,
wherein the analysing means is arranged to identify, from the received router messages, those corresponding to the test data and to analyse such identified router messages in accordance with a plurality of predetermined criteria so as to ascertain how the or each identified router processed the test data.

9. A router according to claim 8, in which the predetermined criteria includes one or more packet forwarding rules that are in operation on the or each identified router, wherein, for each router message corresponding to test data, the analysing means is arranged to perform a process comprising
identifying a packet forwarding rule corresponding to the associated identified router,
evaluating forwarding behaviour to be expected in respect of the received router message corresponding to the test data when processed in accordance with the packet forwarding rule, and
comparing the evaluated forwarding behaviour with the actual behaviour in order to establish how the associated Identified router processed the test data.

10. A router according to any one of the preceding claims, wherein the received router messages are stored in storage (405), said storage (405) being accessible by the analysing means.

11. A routing device (103a) configured to store data corresponding to other routing devices (103b . . . 103g), said data being indicative of the network address of the other routing devices and types of links between such other routing devices,
characterised by
input means arranged to receive input (407) identifying at least one other routing device (103b);
triggering means (401) arranged to send a signal for triggering transmission of link state messages (LSA) from the identified routing device to the said routing device (103a), the link state messages identifying types of links between the identified routing device and; at least one other routing device; and
analysing means (409) arranged to analyse link state messages received from the identified routing device(s) so as to ascertain stability and convergence characteristics corresponding to links associated with the identified routing device.

12. An analyser for analysing distribution of multicast data in a network, wherein the network comprises a plurality of routers (RP1, RP2) each being configured to store data corresponding to a transmitting network device, the said data being indicative of the network address of the transmitting device and a group address corresponding to multicast data transmitted therefrom, the routers additionally being configured to receive requests from other network devices for multicast data and comprising means to access the stored data to identify a network address of a transmitting device corresponding to such a received request, the identified network address being subsequently used to deliver multicast data corresponding to the request to the requesting network device,
each router (RP1) also being arranged to receive and store a router message (SA) from another router (RP2), the router message (SA) comprising data indicative of a network address of a transmitting network device (S1), a group address (G1) corresponding to multicast data transmitted-therefrom and a network address of the other router (RP2), the said data having been stored by the other router (RP2),
wherein at least one router (RP1) comprises
input means arranged to receive input (407) identifying at least one other router (RP2);
triggering means (401) arranged to send a signal for triggering transmission of router messages from the Identified router (RP2) to the said router (RP1); and
the analyzer comprises means (409) arranged to analyse router messages received from the identified router so as to ascertain distribution of multicast data (S1)

13. A method of monitoring the distribution of multicast data in a network, the network comprising a plurality of routers (RP1, RP2) configured to store data corresponding to a transmitting network device the said data being indicative of the network address of the transmitting device and a group address corresponding to multicast data transmitted therefrom, the routers additionally being configured to receive requests from other network devices for multicast data and comprising means to access the stored data to identify a network address of a transmitting device corresponding to such a received request, the identified network address being subsequently used to deliver multicast data corresponding to the request to the requesting network device,
each router (RP1) also being arranged to receive and store a router message (SA) from another router (RP2), the router message (SA) comprising data indicative of a network address of a transmitting network device (S1), a group address (G1) corresponding to multicast data transmitted therefrom and a network address of the other router (RP2) the said data having been stored by the other router (RP2),
characterised by
receiving input (407) identifying at least one other router (RP2);
sending a signal for triggering transmission of router messages from the or each identified router (RP2) to the said router (RP1); and
analysing router messages received from the identified router(s) so as to ascertain distribution of multicast data (S1).

14. A method according to claim 13, including grouping the received router messages in accordance with group address so as to identify, for each group address, which, if any, of the identified routers is not distributing router messages corresponding to the group address.

15. A method according to claim 13 or claim 14, including ascertaining from which of the identified routers the router message was received and identifying a time of receipt thereof.

16. A method according to claim 15, including calculating, for a specified group address, an average gap between instances of receipt of router messages from the identified router corresponding to the specified group address.

17. A method according to any one of claims 13 to 16, including grouping the received router messages in accordance with the network address of transmitting network device, and, for each network address,
evaluating a rate of change of average number of received messages corresponding to the network address;
comparing the evaluated rate of change with a predetermined rate, and
if the evaluated rate of change exceeds the predetermined rate, generating an alarm message.

18. A method according to any one of claims 13 to 17, including grouping the received router messages in accordance with the network address of the identified router from which the router message has been transmitted, and, for each network address,
evaluating a rate of change of average number of received messages;
comparing the evaluated rate of change with a predetermined rate, and
if the evaluated rate of change exceeds the predetermined rate, generating an alarm message.

19. A method according to any one of claims 13 to 18, including grouping the received router messages into a plurality of groups in accordance with the network address of a router at which the multicast data has been stored on behalf of the transmitting network device, and, for each network address,
evaluating a rate of change of average num o received messages;
comparing the evaluated rate of change with a predetermined rate, and
if the evaluated rate of change exceeds the predetermined rate, generating an alarm message.

20. A method according to any one of claims 13 to 19, including receiving input representative of test data to be transmitted by the router, the test data identifying a network address corresponding to a transmitting source of the test data, a group address corresponding to multicast data transmitted therefrom and a network address of a router at which the test data has been stored, the router being arranged to transmit one or more said test data to at (east one of the identified routers,
wherein the method includes identifying, from the received router messages, those corresponding to the test data and to analyse such identified router messages in accordance with a plurality of predetermined criteria so as to ascertain how the or each identified router processed the test data.

21. A method according to claim 20, in which the predetermined criteria includes one or more packet forwarding rules that are in operation on the or each identified router, wherein, for each router message corresponding to test data, the method further includes
identifying a packet forwarding rule corresponding to the associated identified router, evaluating forwarding behaviour to be expected in respect of the received router message corresponding to the test data when processed in accordance with the packet forwarding rule, and
comparing the evaluated forwarding behaviour with the actual behaviour in order to establish how the associated identified router processed the test data.

22. A computer program, or a suite of computer programs, comprising a set of instructions to cause a computer, or a suite of computers, to perform the method steps according to any one of claims 13 to 21.
